(19) United States
(12) Patent Application Publication
(10) Pub. No.: US 2016/0142456 A1
(43) Pub. Date: May 19, 2016

(54) Method and Device for Acquiring Media File

(71) Applicant: Huawei Technologies Co., Ltd., Shenzhen (CN)

(72) Inventor: Jiali Fu, Shenzhen (CN)

(21) Appl. No.: 15/005,228

(22) Filed: Jan. 25, 2016

Related U.S. Application Data
(63) Continuation of application No. PCT/CN2015/079809, filed on May 26, 2015.

(30) Foreign Application Priority Data
Sep. 29, 2014 (CN) 201410513910.X

(51) Int. Cl. H04L 29/06; H04L 29/08

(52) U.S. Cl. CPC H04L 65/4069; H04L 67/22; H04L 65/602

(57) ABSTRACT

A method and device for acquiring a media file. The method includes receiving an acquiring instruction, where the acquiring instruction instructs to acquire a media file, and multiple cue points are preset in the media file; acquiring, according to the acquiring instruction, one or more cue points from the multiple cue points preset in the media file; determining cue point data, corresponding to the one or more cue points, in the media file; and downloading the cue point data, where the cue point data is used to present a segment of content of the media file, so that a user determines whether to acquire all or a part of data of the media file.

### CROSS-REFERENCE TO RELATED APPLICATIONS

This application is a continuation of International Application No. PCT/CN2015/079809, filed on May 26, 2015, which claims priority to Chinese Patent Application No. 201410513910.X, filed on Sep. 29, 2014, both of which are hereby incorporated by reference in their entireties.

### TECHNICAL FIELD

Embodiments of the present disclosure relate to the field of media, and in particular, to a method and device for acquiring a media file.

### BACKGROUND

Generally, when a user watches a media file on a terminal online, the terminal downloads the media file according to a time sequence. The terminal plays a part that is of the media file and has been downloaded, while downloading a subsequent part. However, in the foregoing implementation manner, the user cannot learn a summary of content of the entire media file within a short time, and cannot determine whether actual content of the media file meets an expectation of the user.

The present disclosure aims at resolving the foregoing problem.

### SUMMARY

Embodiments of the present disclosure provide a method and device for acquiring a media file, so that a user can learn a segment of content of a media file within a relatively short time by acquiring cue point data in the media file.

According to a first aspect, the embodiments of the present disclosure provide a method for acquiring a media file, including receiving an acquiring instruction, where the acquiring instruction instructs to acquire a media file, and multiple cue points are preset in the media file, acquiring, according to the acquiring instruction, one or more cue points from the multiple cue points preset in the media file, determining cue point data, corresponding to the one or more cue points, in the media file, and downloading the cue point data, where the cue point data is used to present a segment of content of the media file, so that a user determines whether to acquire all or a part of data of the media file.

In a first possible implementation manner of the first aspect, the acquiring, according to the acquiring instruction, one or more cue points from the multiple cue points preset in the media file includes receiving a specified signal, where the specified signal is used to indicate the one or more cue point, and acquiring, from the multiple cue points preset in the media file, the one or more cue points indicated by the specified signal.

In a second possible implementation manner of the first aspect, the acquiring, according to the acquiring instruction, one or more cue points from the multiple cue points preset in the media file includes selecting, according to bandwidth of a network, the one or more cue points from the multiple cue points preset in the media file.

In a third possible implementation manner of the first aspect, the acquiring, according to the acquiring instruction, one or more cue points from the multiple cue points preset in the media file includes acquiring an information browsing history of the user, and selecting, according to the information browsing history, the one or more cue points from the multiple cue points preset in the media file.

With reference to the first aspect or any one of the first, the second, and the third possible implementation manners of the first aspect, in a fourth possible implementation manner, the determining cue point data, corresponding to the one or more cue points, in the media file includes determining a moment at which the one or more cue points exist, and determining, according to the moment, cue point data corresponding to a corresponding cue point.

With reference to the fourth possible implementation manner of the first aspect, in a fifth possible implementation manner, the determining, according to the moment, cue point data corresponding to a corresponding cue point includes using the first intra frame after the moment or an intra frame at a moment that is before the moment and closest to the moment, as the first frame of the cue point data corresponding to the corresponding cue point, and determining, according to the first frame and a preset quantity of frames or a preset time length, the last frame of the cue point data corresponding to the corresponding cue point.

With reference to the fourth possible implementation manner of the first aspect, in a sixth possible implementation manner, the determining, according to the moment, cue point data corresponding to a corresponding cue point includes using the first frame that is of a scenario obtained after transition and that is after the moment or a frame that is of a scenario obtained after transition and that is at a moment before the moment and closest to the moment, as the first frame of the cue point data corresponding to the corresponding cue point, and determining, according to the first frame and a preset quantity of frames or a preset time length, the last frame of the cue point data corresponding to the corresponding cue point.

With reference to the first aspect or any one of the first to the sixth possible implementation manners of the first aspect, in a seventh possible implementation manner, the method further includes acquiring a content description corresponding to the one or more cue points, and determining whether the cue point data is in accord with the content description, and if it is determined that the cue point data is not in accord with the description, outputting an exception signal, where the exception signal indicates that the cue point data is not in accord with the description.

With reference to the first aspect or any one of the first to the seventh possible implementation manners of the first aspect, in an eighth possible implementation manner, the cue point data includes video data and audio data, and the video data includes at least two frames.

With reference to the first aspect or any one of the first to the eighth possible implementation manners of the first aspect, in a ninth possible implementation manner, the method further includes playing the cue point data to present the segment of the content of the media file.

With reference to the first aspect or any one of the first to the ninth possible implementation manners of the first aspect, in a tenth possible implementation manner, the method further includes receiving a time retrieval instruction, where the acquiring instruction is sent by the user according to the cue point data, and acquiring all or a part of the data of the media file according to the time retrieval instruction.

According to a second aspect, the embodiments of the present disclosure provide a device for acquiring a media file, including an instruction receiving module configured to receive an acquiring instruction, where the acquiring instruction instructs to acquire a media file, and multiple cue points are preset in the media file, a cue point acquiring module configured to acquire, according to the acquiring instruction, one or more cue points from the multiple cue points preset in the media file, a data determining module configured to determine cue point data, corresponding to the one or more cue points, in the media file, and a data downloading module configured to download the cue point data, where the cue point data is used to present a segment of content of the media file, so that a user determines whether to acquire all or a part of data of the media file.

In a first possible implementation manner of the second aspect, the device further includes a signal receiving module configured to receive a specified signal, where the specified signal is used to indicate the one or more cue points, and the cue point acquiring module is further configured to acquire, from the multiple cue points preset in the media file, the one or more cue points indicated by the specified signal.

In a second possible implementation manner of the second aspect, the cue point acquiring module is further configured to select, according to bandwidth of a network, the one or more cue points from the multiple cue points preset in the media file.

In a third possible implementation manner of the second aspect, the device further includes: an information history module configured to acquire an information browsing history of the user, and the cue point acquiring module is further configured to select, according to the information browsing history, the one or more cue points from the multiple cue points preset in the media file.

With reference to the second aspect or any one of the first to the third possible implementation manners of the second aspect, in a fourth possible implementation manner, the data determining module is further configured to determine a moment at which the one or more cue points exist, and determine, according to the moment, cue point data corresponding to a corresponding cue point.

With reference to the fourth possible implementation manner of the second aspect, in a fifth possible implementation manner, the data determining module includes a first frame determining module configured to use the first intra frame after the moment or an intra frame at a moment that is before the moment and closest to the moment, as the first frame of the cue point data corresponding to the corresponding cue point; and a last frame determining module configured to determine, according to the first frame and a preset quantity of frames or a preset time length, the last frame of the cue point data corresponding to the corresponding cue point.

With reference to the fourth possible implementation manner of the second aspect, in a sixth possible implementation manner, the data determining module includes a first frame determining module configured to use the first frame that is of a scenario obtained after transition and that is after the moment or a frame that is of a scenario obtained after transition and that is at a moment before the moment and closest to the moment, as the first frame of the cue point data corresponding to the corresponding cue point, and a last frame determining module configured to determine, according to the first frame and a preset quantity of frames or a preset time length, the last frame of the cue point data corresponding to the corresponding cue point.

With reference to the second aspect or any one of the first to the sixth possible implementation manners of the second aspect, in a seventh possible implementation manner, the device further includes a determining module configured to acquire a content description corresponding to the one or more cue points, and determine whether the cue point data is in accord with the content description, and a signal output module configured to, in a case in which it is determined that the cue point data is not in accord with the description, output an exception signal, where the exception signal indicates that the cue point data is not in accord with the description.

With reference to the second aspect or any one of the first to the seventh possible implementation manners of the second aspect, in an eighth possible implementation manner, cue point data corresponding to each cue point in the one or more cue points includes video data and audio data, and the video data includes at least two frames.

With reference to the second aspect or any one of the first to the eighth possible implementation manners of the second aspect, in a ninth possible implementation manner, the device further includes a playing module configured to play the cue point data to present the segment.

With reference to the second aspect or any one of the first to the ninth possible implementation manners of the second aspect, in a tenth possible implementation manner, the instruction receiving module is further configured to receive a time retrieval instruction, where the acquiring instruction is sent by the user according to the cue point data; and the device further includes a file acquiring module configured to acquire all or a part of the data of the media file according to the time retrieval instruction.

According to a third aspect, the embodiments of the present disclosure provide a system, including a server configured to store a media file, and the device in the second aspect and any one of the first to the ninth possible implementation manners of the second aspect configured to acquire the media file from the server.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a schematic flowchart of a method for acquiring a media file according to Embodiment 1 of the present disclosure;

FIG. 2 is a schematic structural diagram of a device for acquiring a media file according to Embodiment 2 of the present disclosure;

FIG. 3 is another schematic structural diagram of a device for acquiring a media file according to Embodiment 2 of the present disclosure;

FIG. 4 is still another schematic structural diagram of a device for acquiring a media file according to Embodiment 2 of the present disclosure;

FIG. 5 is a schematic structural diagram of a data determining module of a device according to Embodiment 2 of the present disclosure;

FIG. 6 is a schematic structural diagram of a data determining module of a device according to Embodiment 2 of the present disclosure;

FIG. 7 is a schematic structural diagram of a device for acquiring a media file according to Embodiment 3 of the present disclosure; and

FIG. 8 is a schematic structural diagram of a system according to Embodiment 4 of the present disclosure.

### DESCRIPTION OF EMBODIMENTS

The following clearly describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

### Embodiment 1

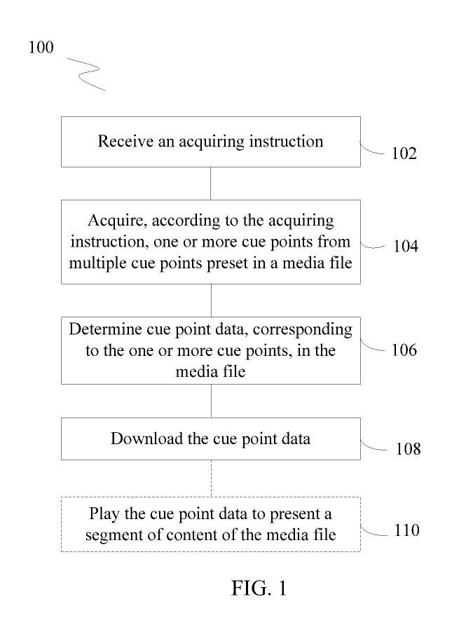

FIG. 1 is a schematic flowchart of a method 100 for acquiring a media file according to Embodiment 1 of the present disclosure.

The method for acquiring a media file includes the following steps.

Step 102: Receive an acquiring instruction. The acquiring instruction instructs to acquire a media file. For example, an instruction, entered by a user, to online play or download a media file (such as an audio file or a video file) is received. Multiple cue points are preset in the media file.

Step 104: Acquire, according to the acquiring instruction, one or more cue points from the multiple cue points preset in the media file. In an embodiment, the acquiring, according to the acquiring instruction, one or more cue points from the multiple cue points preset in the media file includes receiving a specified signal, where the specified signal is used to indicate the one or more cue points, and acquiring, from the multiple cue points preset in the media file, the one or more cue points indicated by the specified signal. For example, the specified signal is sent by a user and indicates the first M cue points, the last N cue points, or any L cue points in the multiple preset cue points, where M, N, and L are constants. In another embodiment, the acquiring, according to the acquiring instruction, one or more cue points from the multiple cue points preset in the media file includes selecting, according to bandwidth of a network, the one or more cue points from the multiple cue points preset in the media file. For example, wider bandwidth of the network indicates more selected cue points. In still another embodiment, the acquiring, according to the acquiring instruction, one or more cue points from the multiple cue points preset in the media file includes acquiring an information browsing history of a user, and selecting, according to the information browsing history, the one or more cue points from the multiple cue points preset in the media file. For example, if the information browsing history of the user includes information related to calligraphy and content that is in the media file and corresponding to two cue points in the multiple preset cue points includes calligraphy, the two cue points are selected.

Step 106: Determine cue point data, corresponding to the one or more cue points, in the media file. A moment to which the one or more cue points belong is determined, and cue point data corresponding to a corresponding cue point is determined according to the moment. The foregoing moment may include multiple moments. Each moment in the multiple moments may be determined according to each cue point in the one or more cue points. In an embodiment, cue point data corresponding to each cue point in the one or more cue points includes video data and audio data, where the video data includes at least two frames.

In an embodiment, the first intra frame after the foregoing moment or an intra frame at a moment that is before the foregoing moment and closest to the foregoing moment is used as the first frame of the cue point data corresponding to the corresponding cue point, and the last frame of the cue point data corresponding to the corresponding cue point is determined according to the first frame and a preset quantity of frames or a preset time length. Furthermore, the first intra frame after each moment in the foregoing multiple moments or an intra frame at a moment that is before each moment and closest to each moment is used as the first frame of the cue point data corresponding to the corresponding cue point, and the last frame of the cue point data corresponding to the corresponding cue point is determined according to the first frame and a preset quantity of frames or a preset time length.

In another embodiment, the first frame that is of a scenario obtained after transition and that is after the foregoing moment or a frame that is of a scenario obtained after transition and that is at a moment before the foregoing moment and closest to the foregoing moment is used as the first frame of the cue point data corresponding to the corresponding cue point, and the last frame of the cue point data corresponding to the corresponding cue point is determined according to the first frame and a preset quantity of frames or a preset time length. Furthermore, the first frame that is of a scenario obtained after transition and that is after each moment in the foregoing multiple moments or a frame that is of a scenario obtained after transition and that is at a moment before each moment and closest to each moment is used as the first frame of the cue point data corresponding to the corresponding cue point, and the last frame of the cue point data corresponding to the corresponding cue point is determined according to the first frame and a preset quantity of frames or a preset time length.

Scenario transition identification may be implemented by using a video scenario transition detection algorithm. In an embodiment, for the video scenario transition detection algorithm, reference may be made to the following literature: Lienhart R. W., “Reliable Transition Detection in Videos: A Survey and Practitioner's Guide” [J], International Journal of Image and Graphics (Int. J. Image Grap.), 2001, 1(3):469-486; Lupatini G., Saraceno C., Leonardi R., “Scene Break Detection: A Comparison” [C], or Silberschatz A., In Proceedings, Eighth International Workshop on Continuous-Media Databases and Applications, Florida: IEEE Press, 1998:34-41.

Step 108: Download the cue point data, where the foregoing cue point data is used to present a segment of content of the media file, so that the user determines whether to acquire all or a part of the content of the media file.

In an embodiment, a segment of the foregoing cue point data forms a summary of the content of the media file. Because a file size of the foregoing cue point data is less than a file size of the entire media file, compared with a case in which the content of the media file can be acquired only after a relatively long time is spent in acquiring the entire media file, in this embodiment, the user can acquire information about the summary of the content of the media file within a relatively short time.

Optionally, a content description corresponding to the one or more cue points may further be acquired, and it is determined whether the cue point data is in accord with the content description. If it is determined that the cue point data is not in accord with the description, an exception signal is output. The exception signal indicates that the cue point data is not in accord with the description. In an embodiment, content that is of the media file and can be presented by the foregoing cue point data may be obtained by using a media content analysis technology, and then it is determined whether the content that is of the media file and can be presented by the foregoing cue point data is in accord with the content description that is of the media file and is corresponding to the foregoing one or more cue points. In an embodiment, for details about the foregoing media content analysis technology, reference may be made to the following literature: Peng Le, Xue Yibo, Wang Chunlu, “Overview of Identifying and Filtering Network Video Content” [J], Computer Engineering and Design, 2008(5):2587-2634. If it is determined that the foregoing cue point data is not in accord with the description, an exception signal is output. The exception signal indicates that the foregoing cue point data is not in accord with the description. For example, content of the exception signal indicates that the user is not advised to download all or a part of data of the media file.

Optionally, this method may further include step 110. Step 110: Play the cue point data to present a segment of the content of the media file. In an embodiment, if the exception signal is output, the foregoing cue point data is not played. In an embodiment, if the foregoing cue point data is in a playable format, this step is directly playing the foregoing cue point data. In another embodiment, if the foregoing cue point data is in an unplayable format, this step is playing a playable file generated according to the foregoing cue point data. Furthermore, a playable file may be separately generated according to cue point data, in the foregoing cue point data, corresponding to each cue point in the one or more cue points, or a playable file is generated according to all the cue point data of the foregoing cue point data.

Optionally, an acquiring instruction may further be received. The acquiring instruction is sent by the user according to the foregoing cue point data. All or a part of the data of the media file is acquired according to the time retrieval instruction. In an embodiment, acquiring all or a part of the data of the media file includes downloading all or a part of the data of the media file. The acquiring instruction indicates at least one of the following parameters: a format for downloading, quality for downloading, a start position for downloading, an end position for downloading, and a resolution for downloading. That is, in this embodiment, a user may determine, within a short time according to a segment that is of content of a media file and presented according to cue point data, whether the content of the media file meets an expectation of the user, so as to determine whether to continue to acquire all or a part of data of the media file, instead of learning, only after spending a long time in acquiring all or a part of the data of the media file, whether the content of the media file meets the expectation of the user.

### Embodiment 2

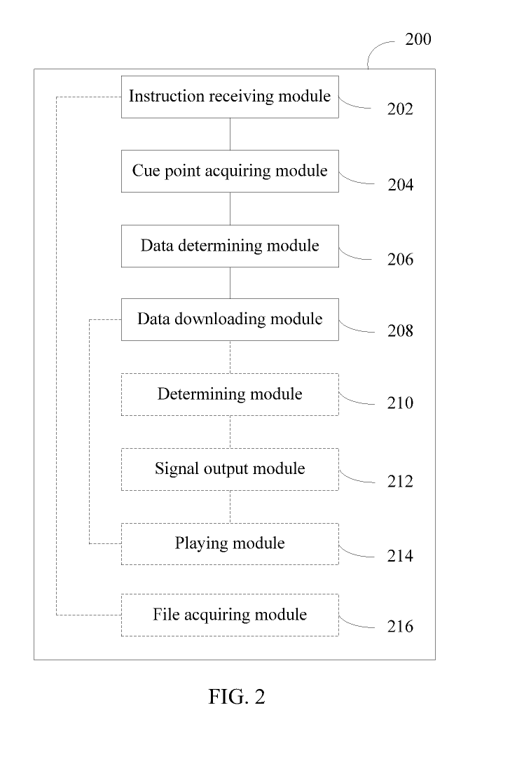

FIG. 2 is a schematic structural diagram of a device 200 for acquiring a media file according to Embodiment 2 of the present disclosure.

The device 200 includes an instruction receiving module 202, a cue point acquiring module 204, a data determining module 206, and a data downloading module 208. The instruction receiving module 202 is configured to receive an acquiring instruction. The acquiring instruction instructs to acquire a media file. Multiple cue points are preset in the media file. The cue point acquiring module 204 is configured to acquire, according to the acquiring instruction, one or more cue points from the multiple cue points preset in the media file. The data determining module 206 is configured to determine cue point data, corresponding to the one or more cue points, in the media file. The data downloading module 208 is configured to download the cue point data. The cue point data is used to present a segment of content of the media file, so that a user determines whether to acquire all or a part of data of the media file.

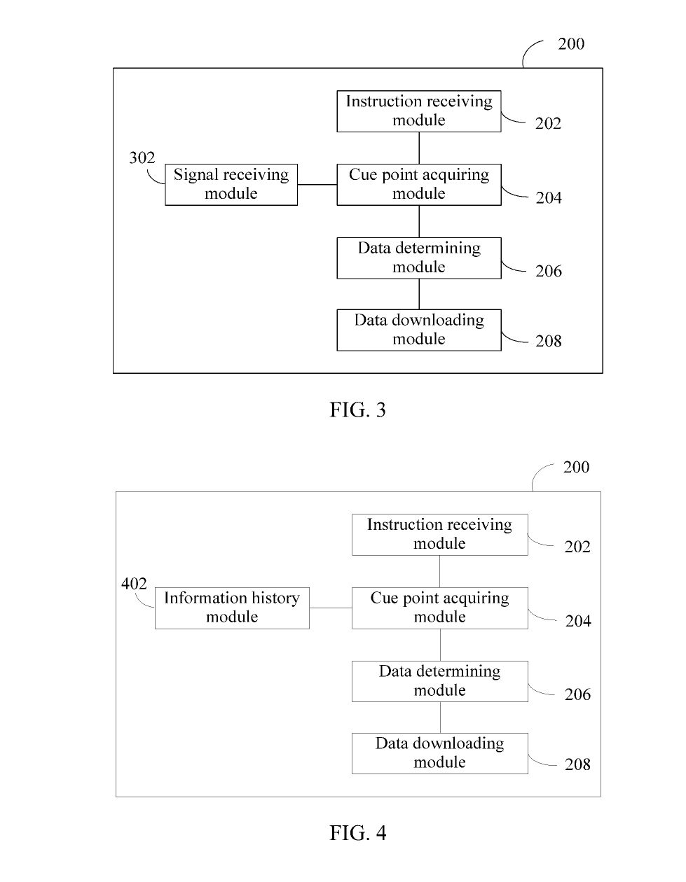

In an embodiment shown in FIG. 3, the device 200 further includes a signal receiving module 302. The signal receiving module 302 is configured to receive a specified signal. The specified signal indicates the one or more cue points. The cue point acquiring module 204 is further configured to acquire, from the multiple cue points preset in the media file, the one or more cue points indicated by the specified signal.

In an embodiment shown in FIG. 4, the device 200 further includes an information history module 402 configured to acquire an information browsing history of the user. The cue point acquiring module 204 is further configured to select, according to the information browsing history, the one or more cue points from the multiple cue points preset in the media file.

In another embodiment, the cue point acquiring module 204 is further configured to select, according to bandwidth of a network, the one or more cue points from the multiple cue points preset in the media file.

The data determining module 206 is further configured to determine a moment at which the one or more cue points exist, and determine, according to the moment, cue point data corresponding to a corresponding cue point. The foregoing moment may include multiple moments. The data determining module 206 may determine each moment in the multiple moments according to each cue point in the one or more cue points. In an embodiment, cue point data corresponding to each cue point in the one or more cue points includes video data and audio data, where the video data includes at least two frames.

In an embodiment shown in FIG. 5, the data determining module 206 includes a first frame determining module 502 and a last frame determining module 504. The first frame determining module 502 is configured to use the first intra frame after the foregoing moment or an intra frame at a moment that is before the foregoing moment and closest to the foregoing moment, as the first frame of the cue point data corresponding to the corresponding cue point. The last frame determining module 504 is configured to determine, according to the first frame and a preset quantity of frames or a preset time length, the last frame of the cue point data corresponding to the corresponding cue point. The first frame determining module 502 is further configured to use the first intra frame after each moment in the foregoing multiple moments or an intra frame at a moment that is before each moment and closest to each moment, as the first frame of the cue point data corresponding to the corresponding cue point. The last frame determining module 504 is configured to determine, according to the first frame and the preset quantity of frames or the preset time length, the last frame of the cue point data corresponding to the corresponding cue point.

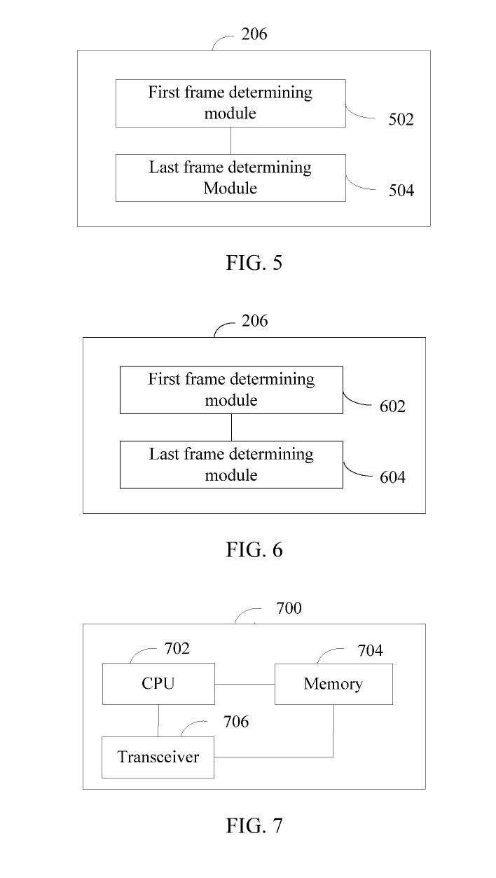

In an embodiment shown in FIG. 6, the data determining module 206 includes a first frame determining module 602 and a last frame determining module 604. The first frame determining module 602 is configured to use the first frame that is of a scenario obtained after transition and that is after the foregoing moment or a frame that is of a scenario obtained after transition and that is at a moment before the foregoing moment and closest to the foregoing moment, as the first frame of the cue point data corresponding to the corresponding cue point. The last frame determining module 604 is configured to determine, according to the first frame and a preset quantity of frames or a preset time length, the last frame of the cue point data corresponding to the corresponding cue point. The first frame determining module 602 is further configured to use the first frame that is of a scenario obtained after transition and that is after each moment in the foregoing multiple moments or a frame that is of a scenario obtained after transition and that is at a moment before each moment and closest to each moment, as the first frame of the cue point data corresponding to the corresponding cue point. The last frame determining module 604 is configured to determine, according to the first frame and the preset quantity of frames or the preset time length, the last frame of the cue point data corresponding to the corresponding cue point.

Optionally, the device 200 further includes a determining module 210 and a signal output module 212. The determining module 210 is configured to acquire a content description corresponding to the one or more cue points, and determine whether the cue point data is in accord with the content description. The signal output module 212 is configured to, in a case in which it is determined that the cue point data is not in accord with the description, output an exception signal. The exception signal indicates that the cue point data is not in accord with the description.

Optionally, the device 200 further includes a playing module 214. The playing module 214 is configured to play the cue point data to present the segment of the content of the media file. In an embodiment, if the signal output module 212 outputs the exception signal, the playing module 214 does not play the cue point data.

In an embodiment, the instruction receiving module 202 is further configured to receive a time retrieval instruction. The acquiring instruction is sent by the user according to the cue point data. The device 200 further includes a file acquiring module 216 configured to acquire all or a part of the data of the media file according to the time retrieval instruction.

In this embodiment, a user may determine, within a short time according to a segment that is of content of a media file and presented the foregoing cue point data, whether the content of the media file meets an expectation of the user, so as to determine whether to continue to acquire all or a part of data of the media file, instead of learning, only after spending a long time in acquiring all or a part of the data of the media file, whether the content of the media file meets the expectation of the user.

### Embodiment 3

FIG. 7 is a schematic structural diagram of a device 700 for acquiring a media file according to Embodiment 3 of the present disclosure.

The device 700 includes a central processing unit (CPU) 702, a memory 704, and a transceiver 706. The transceiver 706 is configured to receive an acquiring instruction. The acquiring instruction instructs to acquire a media file. Multiple cue points are preset in the media file. The memory 704 is configured to store a program instruction. The CPU 702 reads the program instruction from the memory 704 and performs corresponding computing processing. The CPU 702 is further configured to acquire, according to the acquiring instruction, one or more cue points from the multiple cue points preset in the media file. In addition, the CPU 702 is configured to determine cue point data, corresponding to the one or more cue points, in the media file. In addition, the CPU 702 is configured to download the cue point data. The cue point data is used to present a segment of content of the media file, so that a user determines whether to acquire all or a part of data of the media file.

In an embodiment, the transceiver 706 is further configured to receive a specified signal. The specified signal indicates the one or more cue points. The CPU 702 is configured to acquire, from the multiple cue points preset in the media file, the one or more cue points indicated by the specified signal. In another embodiment, the CPU 702 is further configured to select, according to bandwidth of a network, the one or more cue points from the multiple cue points preset in the media file. In still another embodiment, the CPU 702 is further configured to acquire an information browsing history of the user, and select, according to the information browsing history, the one or more cue points from the multiple cue points preset in the media file.

Furthermore, the CPU 702 determines a moment at which the one or more cue points exist, and determines, according to the moment, cue point data corresponding to a corresponding cue point. The foregoing moment may include multiple moments. The CPU 702 may determine each moment in the multiple moments according to each cue point in the one or more cue points. Cue point data corresponding to each cue point in the one or more cue points includes video data and audio data, where the video data includes at least two frames.

In an embodiment, the CPU 702 uses the first intra frame after the foregoing moment or an intra frame at a moment that is before the foregoing moment and closest to the foregoing moment, as the first frame of the cue point data corresponding to the corresponding cue point, and determines, according to the first frame and a preset quantity of frames or a preset time length, the last frame of the cue point data corresponding to the corresponding cue point. Furthermore, the CPU 702 uses the first intra frame after each moment in the foregoing multiple moments or an intra frame at a moment that is before each moment and closest to each moment, as the first frame of the cue point data corresponding to the corresponding cue point, and determines, according to the first frame and the preset quantity of the frames or the preset time length, the last frame of the cue point data corresponding to the corresponding cue point.

In another embodiment, the CPU 702 uses the first frame that is of a scenario obtained after transition and that is after the foregoing moment or a frame that is of a scenario obtained after transition and that is at a moment before the foregoing moment and closest to the forgoing moment, as the first frame of the cue point data corresponding to the corresponding cue point; and determines, according to the first frame and a preset quantity of frames or a preset time length, the last frame of the cue point data corresponding to the corresponding cue point. Furthermore, the CPU 702 uses the first frame that is of a scenario obtained after transition and that is after each moment in the foregoing multiple moments or a frame that is of a scenario obtained after transition and that is at a moment before each moment and closest to each moment, as the first frame of the cue point data corresponding to the corresponding cue point; and determines, according to the first frame and the preset quantity of frames or the preset time length, the last frame of the cue point data corresponding to the corresponding cue point.

In another embodiment, the CPU 702 is further configured to acquire a content description corresponding to the one or more cue points, and determine whether the cue point data is in accord with the content description. If it is determined that the cue point data is not in accord with the description, the transceiver 706 outputs an exception signal. The exception signal indicates that the cue point data is not in accord with the description.

In an embodiment, the CPU 702 is further configured to play the cue point data to present a segment of content of the media file. In an embodiment, the foregoing segment of the cue point data forms a summary of the content of the media file. If the transceiver 706 outputs the exception signal, the CPU 702 does not play the cue point data.

In an embodiment, the transceiver 706 is further configured to receive a time retrieval instruction. The acquiring instruction is sent by the user according to the cue point data. The CPU 702 is configured to acquire all or a part of the data of the media file according to the time retrieval instruction.

In this embodiment, a user may determine, within a short time according to a segment that is of content of a media file and presented the foregoing cue point data, whether the content of the media file meets an expectation of the user, so as to determine whether to further acquire all or a part of data of the media file, instead of learning, only after spending a long time in acquiring all or a part of the data of the media file, whether the content of the media file meets the expectation of the user.

### Embodiment 4

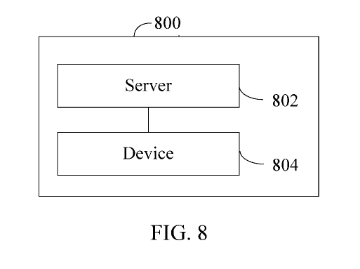

FIG. 8 is a schematic structural diagram of a system 800 according to Embodiment 4 of the present disclosure.

The system 800 includes a server 802 and the device 804 in Embodiment 2. The server 802 is configured to store a media file. The device 804 is configured to acquire the media file from the server 802.

A person of ordinary skill in the art may understand that all or some of the processes of the methods in the embodiments may be implemented by a computer program instructing relevant hardware. The program may be stored in a computer-readable storage medium. When the program runs, the processes of the methods in the embodiments are performed. The foregoing storage medium may include: a magnetic disk, an optical disc, a read-only memory (ROM), or a random access memory (RAM).

What is disclosed above is merely exemplary embodiments of the present disclosure, and certainly is not intended to limit the protection scope of the present disclosure. Therefore, equivalent variations made in accordance with the claims of the present disclosure shall fall within the scope of the present disclosure.

What is claimed is:

1. A method for acquiring a media file, comprising:
receiving an acquiring instruction, wherein the acquiring instruction instructs to acquire a media file, and wherein multiple cue points are preset in the media file;
acquiring, according to the acquiring instruction, one or more cue points from the multiple cue points preset in the media file;
determining the cue point data corresponding to the cue points in the media file; and
downloading the cue point data, wherein the cue point data is used to present a segment of content of the media file such that a user determines whether to acquire all or a part of data of the media file.

2. The method according to claim 1, wherein acquiring, according to the acquiring instruction, the cue points from the multiple cue points preset in the media file comprises:
receiving a specified signal, wherein the specified signal is used to indicate the cue points; and
acquiring, from the multiple cue points preset in the media file, the cue points indicated by the specified signal.

3. The method according to claim 1, wherein acquiring, according to the acquiring instruction, the cue points from the multiple cue points preset in the media file comprises selecting, according to the bandwidth of a network, the cue points from the multiple cue points preset in the media file.

4. The method according to claim 1, wherein acquiring, according to the acquiring instruction, the cue points from the multiple cue points preset in the media file comprises:
acquiring an information browsing history of the user; and
selecting, according to the information browsing history, the cue points from the multiple cue points preset in the media file.

5. The method according to claim 1, wherein determining the cue point data, corresponding to the cue points, in the media file comprises:
determining a moment to which the cue points belong; and
determining, according to the moment, cue point data corresponding to the corresponding cue point.

6. The method according to claim 5, wherein determining, according to the moment, the cue point data corresponding to the corresponding cue point comprises:
using the first intra frame after the moment or an intra frame at a moment that is before the moment and closest to the moment as the first frame of the cue point data corresponding to the corresponding cue point; and
determining, according to the first frame and a preset quantity of frames or a preset time length, the last frame of the cue point data corresponding to the corresponding cue point.

7. The method according to claim 5, wherein determining, according to the moment, the cue point data corresponding to the corresponding cue point comprises:
using the first frame that is of a scenario obtained after transition and that is after the moment or a frame that is of a scenario obtained after transition and that is at a moment before the moment and closest to the moment as the first frame of the cue point data corresponding to the corresponding cue point; and
determining, according to the first frame and a preset quantity of frames or a preset time length, the last frame of the cue point data corresponding to the corresponding cue point.

8. The method according to claim 1, further comprising:
acquiring a content description corresponding to the cue points;
determining whether the cue point data is in accord with the content description; and
outputting an exception signal when the cue point data is not in accord with the description, wherein the exception signal indicates that the cue point data is not in accord with the description.

9. The method according to claim 1, wherein the cue point data comprises video data and audio data, and wherein the video data comprises at least two frames.

10. The method according to claim 1, further comprising playing the cue point data to present the segment of the content of the media file.

11. The method according to claim 1, further comprising:
receiving an acquiring instruction, wherein the acquiring instruction is sent by the user according to the cue point data; and
acquiring all or a part of the data of the media file according to the time retrieval instruction.

12. A device for acquiring a media file, comprising:
a memory; and
a computer processor coupled to the memory, wherein the computer processor is configured to:
receive an acquiring instruction, wherein the acquiring instruction instructs to acquire a media file, and wherein multiple cue points are preset in the media file;
acquire, according to the acquiring instruction, one or more cue points from the multiple cue points preset in the media file;
determine cue point data, corresponding to the cue points, in the media file; and
download the cue point data, wherein the cue point data is used to present a segment of content of the media file such that a user determines whether to acquire all or a part of data of the media file.

13. The device according to claim 12, wherein the computer processor is further configured to:
receive a specified signal, wherein the specified signal is used to indicate the cue points; and
acquire, from the multiple cue points preset in the media file, the cue points indicated by the specified signal.

14. The device according to claim 12, wherein the computer processor is further configured to select, according to bandwidth of a network, the cue points from the multiple cue points preset in the media file.

15. The device according to claim 12, wherein the computer processor is further configured to:
acquire an information browsing history of the user; and
select, according to the information browsing history, the cue points from the multiple cue points preset in the media file.

16. The device according to claim 12, wherein the computer processor is further configured to:
determine a moment at which the cue points exist; and
determine, according to the moment, cue point data corresponding to a corresponding cue point.

17. The device according to claim 16, wherein the computer processor is further configured to:
use one of the first intra frame after the moment and an intra frame at a moment that is before the moment and closest to the moment, as the first frame of the cue point data corresponding to the corresponding cue point; and
determine, according to the first frame and one of a preset quantity of frames and a preset time length, the last frame of the cue point data corresponding to the corresponding cue point.

18. The device according to claim 16, wherein the computer processor is further configured to:
use one of the first frame that is of a scenario obtained after transition, and that is after the moment and a frame that is of a scenario obtained after transition and that is at a moment before the moment and closest to the moment, as the first frame of the cue point data corresponding to the corresponding cue point; and
determine, according to the first frame, and one of a preset quantity of frames and a preset time length, the last frame of the cue point data corresponding to the corresponding cue point.

19. The device according to claim 12, wherein the computer processor is further configured to:
acquire a content description corresponding to the cue points;
determine whether the cue point data is in accord with the content description; and
output an exception signal when the cue point data is not in accord with the content description, and
wherein the exception signal indicates that the cue point data is not in accord with the description.

20. The device according to claim 12, wherein the cue point data corresponding to each cue point comprises video data and audio data, and wherein the video data comprises at least two frames.

21. The device according to claim 12, wherein the computer processor is further configured to play the cue point data to present the segment.

22. The device according to claim 12, wherein the computer processor is further configured to:
receive a time retrieval instruction, wherein the acquiring instruction is sent by the user according to the cue point data; and
acquire all or a part of the data of the media file according to the time retrieval instruction.

23. A system, comprising:
a server configured to store a media file; and
a device configured to acquire the media file from the server, wherein the device comprises:
a memory; and
a computer processor coupled to the memory, wherein the computer processor is configured to:
receive an acquiring instruction, wherein the acquiring instruction instructs to acquire a media file, and wherein multiple cue points are preset in the media file;
acquire, according to the acquiring instruction, one or more cue points from the multiple cue points preset in the media file;
determine cue point data, corresponding to the cue points, in the media file; and
download the cue point data, wherein the cue point data is used to present a segment of content of the media file such that a user determines whether to acquire all or a part of data of the media file.
